(19) United States
(12) Patent Application Publication
(10) Pub. No.: US 2014/0106072 A1
(43) Pub. Date: Apr. 17, 2014

(54) METHODS OF GENERATING A COMPOSITION FOR IDENTIFYING GOODS

(71) Applicant: Smartwater Limited, London (GB)

(72) Inventor: Michael Cleary, London (GB)

(73) Assignee: SMARTWATER LIMITED, London (UK)

(21) Appl. No.: 13/639,098

(22) PCT Filed: Jun. 6, 2012
(86) PCT No.: PCT/GB12/51269

§ 371 Date: Jan. 8, 2013

(30) Foreign Application Priority Data
Jun. 6, 2011 (GB) 1109444.8

(51) Int. Cl. B65C 3/02

(52) U.S. Cl. CPC B65C 3/02
USPC 427/258

(57) ABSTRACT

A method of generating a composition for identifying goods, the composition comprising an indicator material and a plurality of separately identifiable trace materials combined in such a manner to produce unique trace material combinations, the method comprising: defining a group of trace materials; selecting a plurality of trace materials from the group of trace materials to produce a unique combination; maintaining a record of the trace material combination; comparing further combinations of the trace materials to the record of trace material combinations; and either: if the further combination of trace materials is not found in the record, then generating a trace material combination based on the selected plurality of trace materials and recording the generated trace material combination in the record; or if the further combination of trace materials is found in the record of trace material combinations, re-selecting a different combination of trace materials and comparing this different combination to the record of trace material combinations and repeating until a unique combination of trace materials is selected which is not found in the record of trace material combinations, then generating a trace material combination based on the selected plurality of trace materials and recording the generated trace material combination in the record.

### FIELD OF THE INVENTION

The present invention relates to a method of generating a composition for identifying goods. In particular, the present invention relates to a method of generating a composition comprising an indicator material and a plurality of separately identifiable trace material combinations.

### BACKGROUND TO THE INVENTION

Improvements to modern day manufacturing have resulted in high volumes of generic items being mass-produced at a relatively low cost. Although, these items may be relatively cheap to manufacture, their intrinsic value or value imparted by the function they are designed to undertake may be significantly greater. With large numbers of such items being produced the marking of each one is often required for both stock control and warranty purposes.

Commonly these mass-produced items are marked with a serial numbered label allowing each item to be individually identifiable. However, such labels are not only easy to tamper with but are also easily reproducible. Therefore, there is a significant risk that the labels may be changed to indicate a different production date or false labels may be added to a counterfeit item to indicate it is genuine.

Covert markers have been introduced as a means of identifying goods in an attempt to combat counterfeiting. These markers also serve to counter theft by marking goods in a manner that allows ownership to be proven thereby enabling the prosecution of those caught in possession of what can be proved to be stolen goods. Such marker systems, as have been developed by the applicant for many years, have found particular application in the fields of security and crime prevention/deterrence, for example as described in WO 93/07233, GB 2369078, GB 2410208 and GB 2413675, amongst others. Analysis of the surface onto which the marker system is placed or deployed can provide a reliable method of tracing or authenticating items, articles, goods, vehicles or persons.

There is therefore a need for a simple and quick method of generating a marker capable of identifying goods. To ensure the marker is capable of doing so, the method for producing such markers must ensure that each composition generated is unique. Where such markers are produced in large quantities, it must be ensured that the method of production of the marker is robust.

### SUMMARY OF THE INVENTION

The present invention describes methods of producing such markers in a methodical and reliable manner.

In a first aspect of the invention, there is provided a method of generating a composition for identifying goods, the composition comprising an indicator material and a plurality of separately identifiable trace materials combined in such a manner to produce unique trace material combinations, the method comprising: defining a group of trace materials; selecting a plurality of trace materials from the group of trace materials to produce a unique combination; maintaining a record of the trace material combination; comparing further combinations of the trace materials to the record of trace material combinations; and either: if the further combination of trace materials is not found in the record, then generating a trace material combination based on the selected plurality of trace materials and recording the generated trace material combination in the record; or if the further combination of trace materials is found in the record of trace material combinations, re-selecting a different combination of trace materials and comparing this different combination to the record of trace material combinations and repeating until a unique combination of trace materials is selected which is not found in the record of trace material combinations, then generating a trace material combination based on the selected plurality of trace materials and recording the generated trace material combination in the record.

In a further embodiment of the invention, it is provided that where no unique combination of trace materials can be selected from the plurality of trace materials, the method further comprises redefining said group of trace materials to include at least one further trace material not found in said group of trace materials, such that the step of selecting a plurality of trace materials from the group of trace materials to produce a unique combination is selected from the redefined group of trace materials.

The present invention provides for the generation of a composition, or marker, capable of identifying goods on a qualitative only basis, i.e. each component is either there or it is not. Although there is no need for a quantitative assessment of the components, or trace materials, to be conducted to positively identify the goods, the present invention does not exclude the use of such assessment techniques. By allowing for identification based only on qualitative assessment, the present invention maximises the reliability of the marker.

In one embodiment of the invention, it is provided that the qualitative assessment as to whether a trace material is present. Preferably, the qualitative assessment is based upon the component being present at 10 times the background level of that component in the environment in which the marker was sampled. To facilitate this measurement a reference sample may be taken from an unmarked area immediately adjacent to the marker. Analysis of the marker sample and reference sample, by whatever means, enables the determination of the presence of each trace material in the composition. This analysis may be used as prima facie evidence in a court of law.

In one embodiment of the invention, the generation of trace material combinations may be generated sequentially or randomly. When generated sequentially and in the case of a qualitative only basis for the marker composition, the first trace material of a mixture may be chosen from the full range of trace materials available. That trace material may then be excluded from the choice of the other trace materials of the mixture. This process may continue for all the trace materials in the mixture, as when each one is used it may be barred from further use within that particular composition.

In a further embodiment of the invention, the group of trace materials may be defined through the use of various methods of labelling each component of the mixture. These labelling methods may include alphabetic, alphanumeric, hexadecimal and/or purely numerical labelling.

In one embodiment the group of trace materials may be defined through the use of alphabetic labelling. This may be accomplished by assigning a letter to each of the plurality of trace materials, i.e. all the possible components, that could be used in the mixture. For example, component or trace material “1” could be assigned any letter from “A” to “Z”. If, for example, more than 26 separately identifiable trace materials or components are available for use in the composition, then the lettering may be multiplied to ensure a unique label; i.e. “AA”, “AB”, “AC”, etc.

Preferably, the record of trace material combinations is such that the descriptor or label for each component or trace material can be distinguished from two individual descriptors. For example, if the generated trace material combination was based upon the presence of components “A” and “B” then it would be preferable for the record of this combination to be distinguishable from the record of the combination containing the component “AB”. Preferably, a separator may be used between components such as a comma or other punctuation marks or symbols.

In a further embodiment of the invention, the record of trace material combinations may discriminate between letters by using higher and lower case. For example:

A composition containing the first and second trace materials, components “A” and “B”, could be written “AB”; A composition containing the first and twenty-seventh trace materials, components “A” and “a” could be written as “Aa”.

In a further embodiment of the invention, the group of trace materials may be defined through the use of an alphanumeric approach. This approach may provide further discrimination in mixtures of greater complexity. Preferably, letters may be used and then combinations of letters with numbers. This allows for a further basis of maintaining the record of trace material combinations.

In a further embodiment of the invention, the group of trace materials may be defined through the use of hexadecimal notation. This notation can also be used as the basis for the description of more complex mixtures.

In a further embodiment of the invention, the group of trace materials may be defined through the use of purely mathematical descriptors. Preferably, the group of trace materials may be defined by decimal, binary and/or octal descriptors.

In a further embodiment of the invention, it is provided that the string defining a binary and/or octal based combination of trace materials, may be used to ensure a component is excluded from a mixture, thereby providing a bar, when it is already present in the composition; for example, when the combination of trace materials is generated sequentially. Preferably, the string may provide the bar such that in a string of “N” components, the “Nth” component is always present. Without this, a mixture of 5 from 10 possible components could potentially be the same as a mixture of 5 from 9; however with this restriction imposed there is no possibility of such duplication.

In one embodiment of the invention, it is provided that once the trace material combination is generated based on the selected plurality of trace materials, the combination can then be manufactured. In one embodiment, it is provided that the composition is manufactured by hand. Preferably, the composition is manufactured on an automated production unit. Preferably, the automated production unit is operable to maintain a record of the trace material combinations which have been manufactured.

In a further embodiment of the invention, it is provided that once a composition has been sold and/or allocated to a particular proprietor, the owner's details may be added to the record of trace material combinations previously used. This extended record serves to indicate that the marker has been sold to a specific customer thereby ensuring that the marked goods are identifiable.

The marker preferably comprises an indicator material, which can quickly provide a preliminary, gross indication of the presence of a composition according to the invention. The indicator material can either be “overt” or “covert.” An overt material is typically one which can be seen unaided by technology, such as a dye or pigment. With an overt indicator, it is immediately evident from an observation of the article or person that a mark has been provided thereon which may act as a deterrent. In one embodiment both a covert and overt mark may be applied thus combining the deterrent effect of the overt mark with the covert properties of the covert mark. For example, if the overt mark failed to act as a deterrent and the perpetrator tried to remove the overt mark; even if they were successful the stolen item could nevertheless still be identified by virtue of the covert mark.

A covert indicator will remain hidden until some technical means or stimulus is used to make it obvious. Usually, a covert indicator will become visible upon application of a radiation source other than visible light, and of these, fluorescent indicators are most common. Thus, the covert indicator will often be at least one fluorescent material, and which is easily detectable upon examination with ultraviolet light, for example.

It is possible to utilise a fluorescent material which when exposed to UV light or IR light fluoresces in a particular colour, each particular fluorescent material being selected for a particular customer, so that when the composition containing the selected fluorescent material is applied to a surface of articles or goods, then any unauthorised removal of such articles or goods can be linked back to the particular customer as the source of goods. It is further possible to utilise a combination of two or more fluorescent materials having differing A. max emission wavelengths.

It is possible to identify said two or more materials by utilising a UV-absorption spectrum or a fluorescent emission spectrum of an indicator. Accordingly, such combination of materials, when applied to a surface of articles or goods, can also be used to link the particular goods to the customer. Alternatively or additionally, the indicator may comprise at least one phosphorescent material capable of phosphorescing when subjected to stimulus.

When the gross indicator means is fluorescent, the composition can include one or more of any suitable fluorescent materials.

An item, an article, a good, a vehicle and/or premises comprising a surface coated or otherwise impregnated with the marker system also forms part of the present invention as does the composition generated by the method described herein.

### Exemplary Embodiment

The invention will now be further described with reference to the following exemplary embodiment. Although several different approaches to generating a cornposition for identifying goods have been detailed above, the following examples demonstrate what could be done to produce a 10 component marker chosen from 30 possible trace materials.

### Alphabetic

The following code ABCcJXMaLZ represents a composition containing the 1^{st}, 2^{nd}, 3^{rd}, 29^{th}, 10^{th}, 24^{th}, 13^{th}, 27^{th}, 12^{th} and 26^{th} trace materials. As can be seen this code may have been produced using random number generation.

This mixture can then be labelled using the further coding systems:

### Alphanumeric

This labelling system is preferable for use with complex mixtures; however the same mixture as described above would give the following code.:
ABCC1JXMA1LZ

### Hexadecimal

This labelling system is also preferable for use with complex mixtures, and the same mixture as described above would be coded as follows:
1231da18d1bc1a

### Binary,

Bearing In mind that binary strings may be written and read from right to left, the same mixture as described above would be coded in binary as:
010110100000000001101000000111

### Octal

The same mixture as described above would be coded as follows:
1,2,3,35,12,30,15,33,14,32

Each of the approaches above requires the constraints described by the present invention so that they may be used as a method for the generation of unique formulations of components suitable for use as unique markers.

Various alterations and modifications may be made to the present invention without departing from the scope of the invention.

A number of embodiments have been described herein. However, it will be understood by persons skilled in the art that other variants and modifications may be made without departing from the scope of the embodiments as defined in the ciairns appended hereto.

1. A method for manufacturing a uniquely identifiable cable, comprising the steps of:
providing one or more wires to be included in a cable;
applying a marker system to said one or more wires; and
coating the one or more wires having the marker thereon with an insulating layer to form the cable.

2. The method of claim 1, wherein more than one marker system is applied so that different markers are on different lengths of the said one or more wires.

3. The method of claim 2, wherein the marker systems are applied consecutively on the one or more wires.

4. The method of claim 1, wherein a plurality of wires are provided for inclusion in said cable and which plurality of wires are entwined to form a wire assembly, the marker system being applied to the wires prior to or after the formation of said wire assembly.

5. The method of claim 4, wherein the marker system is applied to the wires prior to or after the step of annealing the wire assembly.

6. The method of claim 1, wherein the marker system comprises a suspension.

7. The method of claim 6, wherein a suspension is used in cases where a single marker system is applied to the one or more wires or optionally where a single marker system is applied to a substantial length of the one or more wire.

8. The method of claim 1, further comprising a reservoir, providing the reservoir containing the marker system.

9. The method of claim 8, wherein the reservoir is stirred to avoid settlement in the suspension.

10. The method of claim 9, wherein a roller may be used to stir the reservoir to prevent settlement in the suspension.

11. The method of claim 10, wherein the reservoir is a stirred reservoir to prevent settlement in the suspension.

12. The method of claim 8, wherein the a size of the reservoir is varied dependent on the amount of marker system to be applied to the one or more cables.

13. The method of claim 8, wherein one or more racks are provided.

14. The method of claim 13, wherein the one or more racks are configured to receive and hold one or more reservoirs, such that the one or more racks provide storage when the one or more reservoirs are not in use.

15. The method of claim 1, wherein the marker system is applied to the cable by roller.

16. The method of claim 1, wherein the marker system is applied to the cable by brushing.

17. The method of claim 1, wherein the marker system is applied to the cable by drops.

18. The method of claim 1, wherein the marker system is applied to the cable by spray.

19. The method of claim 1, wherein the insulation layer comprises a plastic type material.

20. The method of claim 1, wherein the insulation layer comprises polyvinyl chloride.

21. The method of claim 1, wherein the insulation layer comprises polyethylene.

22. The method of claim 1, wherein a T-shaped extrusion head is used to coat the wire assembly with the insulation layer.

23. The method of claim 22, wherein the metal runs through the straight section of the T-shaped extrusion head.

24. The method of claim 1, wherein the marker system comprises a matrix and an aqueous polymer emulsion to bind the marker system to the surface of the marked goods.

25. The method of claim 24, wherein the polymer system is water based.

26. The method of claim 1, wherein the marker system further comprises a unique fingerprint capable of distinguishing one marker system from that of another and to identify the source of the item to which it is coupled.

27. The method of claim 26, wherein the fingerprint comprises a solvent medium and one or more trace materials.

28. The method of claim 27, wherein the trace materials comprise metal compounds or unique sequences of nucleic acids.

29. The method of claim 27, wherein the one or more trace materials are assigned constant positions in a binary string.

30. The method of claim 27, wherein the trace materials are assigned to constant position in an octal string.

31. The method of claim 1, wherein the marker system further comprises an indicator material.

32. The method of claim 31, wherein the indicator material is overt and can be seen unaided by technology.

33. The method of claim 32, wherein the indicator is a dye and/or optionally a pigment.

34. The method of claim 31, wherein the indicator material is covert and will remain hidden until subjected to a predefined stimulus.

35. The method of claim 1, wherein indicator material is both a covert and overt mark.

36. The method of any preceding claim 1, wherein the marker system is heat resilient, such that the marker system is capable of withstanding high temperatures.

37. The method of claim 36, wherein the marker system is heat resilient when subjected to temperatures up to 200° C.

38. (canceled)

39. (canceled)

40. (canceled)
